(19) United States
(12) Patent Application Publication
(10) Pub. No.: US 2024/0354856 A1
(43) Pub. Date: Oct. 24, 2024

(54) METHOD, SERVER AND SYSTEM FOR PROVIDING MOVABLES MANAGEMENT SERVICE

(71) Applicant: C&TECH CO., LTD., Daejeon (KR)

(72) Inventors: Ki Duk KIM, Daejeon (KR); Soo Eun KIM, Seoul (KR); Jeong Ho LEE, Daejeon (KR)

(21) Appl. No.: 18/369,299

(22) Filed: Sep. 18, 2023

(30) Foreign Application Priority Data
Apr. 19, 2023 (KR) 10-2023-0051368

(51) Int. Cl. G06Q 40/06

(52) U.S. Cl. CPC G06Q 40/06

(57) ABSTRACT

A method for providing a movables management service includes receiving measurement data collected by a financial information acquisition device attached to a movables from the financial information acquisition device, deriving state information associated with at least one of the movables and the financial information acquisition device from the measurement data, and transmitting the state information to a holder terminal owned by a collateral entity setting up a collateral right for the movables. The state information may include at least one of the location information and preset event detection information of the movables.

### CROSS REFERENCE TO RELATED APPLICATION AND CLAIM OF PRIORITY

This application claims the benefit under 35 USC § 119 of Korean Patent Application No. 10-2023-0051368 filed on Apr. 19, 2023, in the Korean Intellectual Property Office, the entire disclosure of which is incorporated herein by reference for all purposes.

### BACKGROUND

### 1. Field of the Invention

Apparatuses and methods consistent with the disclosure relate to a method, a server and a system for providing a movables management service, and more particularly, to a method, a server and a system for providing a service on state information of a movables.

### 2. Description of the Related Art

In a capitalist society, it is common for a debtor to receive a loan from a financial sector. Here, the financial sector may determine the debtor's loanable amount by referring to the debtor's credit rating. In addition, when the debtor's loan amount exceeds a certain level or the debtor's credit rating is insufficient, the debtor may default on the debt. Therefore, in order to prepare for this possibility, the financial sector can secure a part of property owned by the debtor as collateral. That is, the financial sector such as a bank can hold the debtor's personal property as the collateral, lend money to the debtor, and change ownership of the property held as the collateral if the debtor defaults on the debt within a specified period.

However, unlike real estate which is always fixed among the properties owned by the debtor such as an individual or a corporation, in a case of a movables, a collateral value may be changed based on a state of the movables, which can cause difficulties for a creditor. Therefore, there is a need to constantly monitor the state of the movables.

### SUMMARY

The disclosure provides a method, a server and a system for providing a movables management service to a holder of a movables by generating state information of the movables based on information on the movables.

According to an embodiment of the disclosure, provided is a method for providing a movables management service that is performed by a server for providing a movables management. The method includes: receiving measurement data collected by a financial information acquisition device attached to a movables from the financial information acquisition device: deriving state information associated with at least one of the movables and the financial information acquisition device from the measurement data; and transmitting the state information to a holder terminal owned by a collateral entity setting up a collateral right for the movables, wherein the state information includes at least one of the location information and preset event detection information of the movables.

The location information may be derived from positioning data acquired from at least one of the financial information acquisition device and a communication infrastructure associated with the financial information acquisition device.

The event detection information may be derived by detecting at least one of a first event associated with a state of the financial information acquisition device and a second event associated with the location information and activation state of the movables.

The method may further include: storing the state information; and generating analysis information associated with the movables based on the state information and at least one state information derived from at least one measurement data previously received from the financial information acquisition device.

The generating of the analysis information may include: checking a predetermined collateral value of the movables: subtracting the predetermined collateral value based on the state information and the at least one state information; and transmitting information on the subtracted collateral value to the holder terminal.

The transmitting of the state information may further include transmitting a notification signal corresponding to the state information to a manager terminal preset for the movables.

According to another embodiment of the disclosure, provided is a server for providing a movables management service. The server includes: a communication module receiving measurement data collected by a financial information acquisition device attached to a movables from the financial information acquisition device and transmitting state information to a holder terminal owned by a collateral entity setting up a collateral right for the movables; and a processor deriving the state information associated with at least one of the movables and the financial information acquisition device from the measurement data, wherein the state information includes at least one of the location information and preset event detection information of the movables.

The location information may be derived from positioning data acquired from at least one of the financial information acquisition device and a communication infrastructure associated with the financial information acquisition device.

The event detection information may be derived by detecting at least one of a first event associated with a state of the financial information acquisition device and a second event associated with the location information and activation state of the movables.

The server may further include a memory storing the state information, wherein the processor generates analysis information associated with the movables based on the state information and at least one state information derived from at least one measurement data previously received from the financial information acquisition device.

The processor may check a predetermined collateral value of the movables, subtract the predetermined collateral value based on the state information and the at least one state information, and transmit information on the subtracted collateral value to the holder terminal.

The communication module may transmit a notification signal corresponding to the state information to a manager terminal preset for the movables.

According to still another embodiment of the disclosure, provided is a system for providing a movables management service. The system includes: a financial information acquisition device attached to a movables to collect measurement data of the movables: a server for providing a movables management service receiving the measurement data from the financial information acquisition device and deriving state information associated with at least one of the movables and the financial information acquisition device from the measurement data; and a holder terminal owned by a collateral entity setting up a collateral right for the movables and receiving the state information.

Location information may be derived from positioning data acquired from at least one of the financial information acquisition device and a communication infrastructure associated with the financial information acquisition device.

Event detection information may be derived by detecting at least one of a first event associated with a state of the financial information acquisition device and a second event associated with the location information and activation state of the movables.

The server for providing the movables management service may store the state information, and generate analysis information associated with the movables based on the state information and at least one state information derived from at least one measurement data previously received from the financial information acquisition device.

The server for providing the movables management service may check a predetermined collateral value of the movables, subtract the predetermined collateral value based on the state information and the at least one state information, and transmit information on the subtracted collateral value to the holder terminal.

The server for providing the movables management service may transmit a notification signal corresponding to the state information to a manager terminal preset for the movables.

The embodiments of the disclosure may have effects including the following advantages. However, it does not indicate that the embodiments of the disclosure should include all of these advantages, the scope of the disclosure should not be understood as being limited thereto.

The method, the server and the system for providing the movables management service according to the embodiments of the disclosure may provide the state information of the movables for the creditor to easily monitor the location of the movables and the occurrence of the events.

In addition, the method, the server and the system for providing the movables management service according to the embodiments of the disclosure may dynamically calculate the collateral value of the movables based on the state information of the movables.

### BRIEF DESCRIPTION OF THE DRAWINGS

FIG. 1 is a view schematically showing a system for providing a movables management service according to an embodiment of the disclosure.

FIG. 2 is a view showing that a server for providing a movables management service estimates and verifies location of movables.

FIG. 3 is a flowchart showing a method for providing a movables management service according to another embodiment of the disclosure.

FIG. 4 is a detailed flowchart showing specific operations of operations performed after a step S330 of FIG. 3.

FIG. 5 is a block diagram of the server for providing the movables management service according to still another embodiment of the disclosure.

### DETAILED DESCRIPTION

The disclosure may be variously modified and have several embodiments. Therefore, specific embodiments of the disclosure are shown in the accompanying drawings and described in detail. However, it is to be understood that the disclosure is not limited to the specific embodiments, and includes all modifications, equivalents, and substitutions, included in the spirit and scope of the disclosure.

Terms such as “first”, “second”, “A”, “B” and the like may be used to describe various components, and the components are not to be interpreted to be limited by the terms. The terms are used only to distinguish one component from another component. For example, a first component may be named a second component and the second component may also be similarly named the first component, without departing from the scope of the present disclosure. A term, “and/or” includes a combination of a plurality of related items or any one of the plurality of related items.

It is to be understood that when one element is referred to as being “connected to” or “coupled to” another element, one element may be connected directly to or coupled directly to another element or connected to or coupled to another element while having a third element interposed therebetween. On the other hand, it is to be understood that when one component is referred to as being “directly connected to” or “directly coupled to” another component, one component may be connected or coupled to another component without a third component interposed therebetween.

Terms used in the specification are used only to describe the specific embodiments rather than limiting the disclosure. A term of a singular number may include its plural number unless explicitly indicated otherwise in the context. It is to be further understood that terms such as “comprise”, “include” and the like, used in this specification specify the presence of features, numerals, steps, operations, components, parts, or combinations thereof, mentioned in the specification, and do not preclude the presence or addition of one or more other features, numerals, steps, operations, components, parts or combinations thereof.

Unless defined otherwise, it is to be understood that all the terms used in the specification including technical and scientific terms have the same meanings as those that are generally understood by those skilled in the art. It should be interpreted that terms defined by a generally used dictionary have the same meanings as their meanings within the context of the related art, and these terms should not be ideally or excessively formally interpreted unless the context clearly dictates otherwise.

Prior to providing a detailed description of the disclosure with referenced to the drawings, it is to be clarified that the components in the specification are divided from each other only by the main function of each component. That is, two or more components described below may be combined into one component or one component may be divided into two or more components for each more subdivided function.

In addition, each component described below may additionally perform some or all of functions of another component in addition to its main function, and some of the main functions of each component may be dedicated to and performed by another component. Therefore, the presence or absence of each component described in the specification should be functionally interpreted.

In the specification, “A or B” may indicate “only A”, “only B” or “both A and B”. In other words, “A or B” in the specification may be interpreted as “A and/or B”. For example, “A, B, or C” in the specification may indicate “only A”, “only B”, “only C”, or “any combination of A, B and C”.

A slash (/) or a comma (,) used in the specification may indicate “and/or”. For example, “A/B” can indicate “A and/or B”. Accordingly, “A/B” can indicate “only A”, “only B”, or “both A and B”. For example, “A, B, C” can indicate “A, B or C”.

“At least one of A and B” in the specification may indicate “only A”, “only B” or “both A and B”. In addition, an expression “at least one of A or B” or “at least one of A and/or B” in the specification may be interpreted the same as “at least one of A and B”.

In addition, “at least one of A, B and C” in the specification may indicate “only A”, “only B”, “only C”, or “any combination of A, B and C”. In addition, an expression “at least one of A, B or C” or “at least one of A, B and/or C” may indicate “at least one of A, B and C”.

Hereinafter, the embodiments of the disclosure are described in more detail with reference to the accompanying drawings. In order to facilitate the entire understanding of the disclosure in describing the disclosure, the same components are denoted by the same reference numerals throughout the accompanying drawings, and an overlapped description for the same components is omitted.

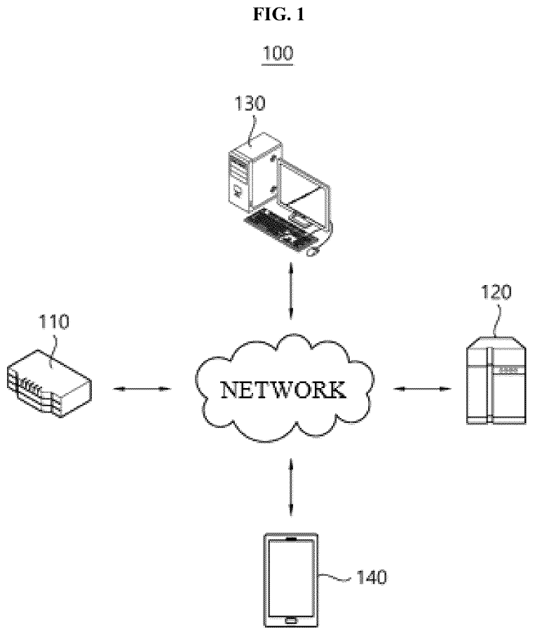

Prior to the description provided with reference to FIG. 1, the terms mentioned in the disclosure are defined as follows.

Movables indicate all types of property other than real estate, i.e., movable property owned by an individual or a corporation. For example, the movables may include vehicles, electronic devices, mechanical devices, furniture, jewelry, accessories, clothing, belongings, household items, and the like. That is, the movables can be used as having a dictionary meaning concept that includes all types of property other than the real estate. The description describes a case where the movables described below is a vehicle as an example. However, the movables may use another type of movables described above.

A holder indicates a collateral entity setting up a collateral right for the movables. For example, the holder may be a financial sector that grants a loan to an owner of the movables by setting the movables as a collateral. Accordingly, the owner of the movables can be referred to as a debtor and the holder can be referred to as a creditor.

A manager indicates an entity set in advance for managing the movables. For example, the manager may be an operating entity (e.g., operating company, management company, service company) of a server or system for providing a movables management service. The manager may be referred to as a financial planner (FP) or a movables manager based on a type of the movables.

@FIG. 1 is a view schematically showing a system for providing a movables management service according to an embodiment of the disclosure.

Referring to FIG. 1, a system 100 for providing a movables management service according to this embodiment is a system for providing a movables management service based on measurement data, and may include a financial information acquisition device 110, a server 120 for providing a movables management service, a holder terminal 130, and a manager terminal 140. A business model (BM) for providing the movables management service can be implemented based on the system 100 for providing the movables management service of FIG. 1.

The financial information acquisition device 110 is a device attached to a movables to collect the measurement data. Being attached to the movables may indicate being maintained to be in contact with the movables or mounted in the movables. That is, the financial information acquisition device 110 may collect the measurement data related to the movables in a state where the device is attached to the movables. For example, the financial information acquisition device 110 may collect at least one of positioning information (or positioning data) of the movables, state information of the financial information acquisition device 110, and activation information of the movables. In order to collect the positioning data, the financial information acquisition device 110 may be mounted with a device such as a global positioning system (GPS) receiver. In addition, in order to collect the state information of the financial information acquisition device 110, and the activation information of the movables, the financial information acquisition device 110 may be mounted with a sensor such as a vibration sensor, a current sensor, a voltage sensor, a temperature sensor, or the like. The financial information acquisition device 110 may be implemented as a communication terminal, an internet of things (IoT) terminal, a set-top terminal, a portable terminal, a smart terminal, a personal digital assistant (PDA), a laptop computer, or the like. The description describes a case where the financial information acquisition device 110 described below is the set-top terminal as an example. However, the financial information acquisition device 110 may use another type of terminal described above.

The server 120 for providing the movables management service is a device deriving the state information by receiving the measurement data collected by the financial information acquisition device 110. The state information derived by the server 120 for providing the movables management service may include at least one of the location information and preset event detection information of the movables. The state information indicates information derived by processing or transforming the measurement data received from the financial information acquisition device 110 in order for the server 120 for providing the movables management service to provide the holder having the movables as the collateral with the movables management service.

For example, the server 120 for providing the movables management service may derive the location information of the movables as the state information, the location information being derived from the positioning data acquired from at least one of the financial information acquisition device 110 and a communication infrastructure associated with the financial information acquisition device 110. For another example, the server 120 for providing the movables management service may derive the event detection information of the movables as the state information, the event detection information being derived from at least one of the state information of the financial information acquisition device 110 and the activation information of the movables, received from the financial information acquisition device 110. The server 120 for providing the movables management service may be implemented as an IoT server, a cloud server, an edge server, a router, a gateway, a personal computer (PC), a smart terminal, or the like. The description describes a case where the server 120 for providing the movables management service described below is the gateway as an example. However, the server 120 may use another type of server described above.

The holder terminal 130 is a device owned by the collateral entity setting up the collateral right for the movables. The holder terminal 130 may receive the state information from the server 120 for providing the movables management service. The holder can monitor the movables in real time by using the state information received from the holder terminal 130. The holder terminal 130 may be implemented as the communication terminal, the IoT terminal, the portable terminal, the smart terminal, the PC, the PDA, the laptop computer, or the like. The description describes a case where the holder terminal 130 described below is the PC as an example. However, the holder terminal 130 may use another type of terminal described above.

The manager terminal 140 is a device receiving a notification signal corresponding to the state information from the server 120 for providing the movables management service. The notification signal may include a history of when and to whom the state information derived by the server 120 for providing the movables management service is transmitted. That is, when the server 120 for providing the movables management service transmits the state information to the holder terminal 130, the notification signal corresponding to the state information may be transmitted to the manager terminal 140. The manager terminal 140 may be implemented as the communication terminal, the IoT terminal, the portable terminal, the smart terminal, the PC, the PDA, the laptop computer, or the like. The description describes a case where the manager terminal 140 described below is the smart terminal as an example. However, the manager terminal 140 may use another type of terminal described above.

The server 120 for providing the movables management service may receive, from the financial information acquisition device 110, at least one of positioning data of the financial information acquisition device 110 and positioning data of the communication infrastructure associated with the financial information acquisition device 110. The server 120 can then derive the location information of the movables from the received positioning data. The description above describes that the financial information acquisition device 110 is attached to the movables, and a location of the financial information acquisition device 110 and a location of the movables may be the same as each other in a normal monitoring situation. Accordingly, when receiving the positioning data of the financial information acquisition device 110 from the financial information acquisition device 110, the server 120 for providing the movables management service may derive the location (i.e., a point, a spot, or coordinates) corresponding to the positioning data as the location information of the movables.

Meanwhile, the server 120 may derive the location information of the movables as described above from the positioning data of the communication infrastructure associated with the financial information acquisition device 110 rather than the positioning data of the financial information acquisition device 110. For example, the server 120 for providing the movables management service may derive the vicinity (i.e., range or area) of received positioning data as the location information of the movables when receiving the positioning data of the communication infrastructure associated with the financial information acquisition device 110 from the financial information acquisition device 110.

Meanwhile, the server 120 for providing the movables management service may receive, from the financial information acquisition device 110, at least one of information associated with a state of the financial information acquisition device 110 and information associated with an activation state of the movables. The information associated with the state of the financial information acquisition device 110 may include information on on/off of the financial information acquisition device 110 and information indicating whether the financial information acquisition device 110 is attached to the movables. In addition, the information associated with the activation state of the movables may include information on on/off of the movables, information indicating vibration, noise, current change, voltage change, and temperature change, occurring during the activation. The information may be collected by the sensor mounted in the financial information acquisition device 110 and then transmitted to the server 120 for providing the movables management service.

Meanwhile, the server 120 for providing the movables management service may derive the event detection information from at least one of the information associated with the state of the financial information acquisition device 110 and the information associated with the activation state of the movables. The server 120 may derive the event detection information by detecting a first event associated with the state of the financial information acquisition device 110, a second event associated with the activation state of the movables, or both the events. For example, the server 120 may detect the information on the on/off of the financial information acquisition device 110 as first event information. For another example, the server 120 may detect the information on the on/off of the movables as second event information.

The server 120 for providing the movables management service may derive the event detection information by detecting at least one of the first event information and the second event information. The event detection information may be information generated by the server 120 for providing the movables management service for the holder's monitoring. For example, when detecting the information on the on/off of the financial information acquisition device 110 as the first event information, the server 120 for providing the movables management service may derive the event detection information indicating that the financial information acquisition device 110 is normal or the financial information acquisition device 110 is abnormal. For another example, when detecting the information on the on/off of the movables as the second event information, the server 120 for providing the movables management service can derive the event detection information indicating that the movables is active or the movables is inactive.

In this way, the server 120 for providing the movables management service may derive the state information including at least one of the location information derived from the positioning data and the event detection information derived from the event detection. The state information can be derived in various forms such as an image, sound, and a text for the holder's monitoring convenience.

The server 120 for providing the movables management service may transmit the state information to the holder terminal 130. The holder can monitor the movables by using the state information output by the holder terminal 130. For example, the server 120 for providing the movables management service may provide the service for the holder to monitor the movables by transmitting the state information for the image to be output through a screen of the holder terminal 130 or for the sound to be output through a speaker.

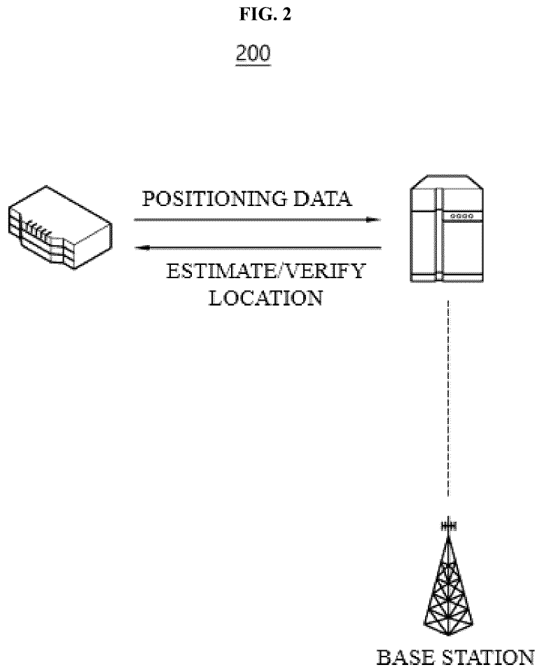

FIG. 2 is a view showing that the server for providing the movables management service estimates and verifies the location of the movables.

Referring to FIG. 2, the server 120 for providing the movables management service may receive the collected positioning data from the financial information acquisition device 110. The positioning data may be information used to identify a location of a target, such as GPS information. The description describes the GPS information as an example of the positioning data. However, the positioning data may use another information (e.g., global navigation satellite system (GNSS) information, information publication scheme (IPS) information, cell information, geomagnetic sensor information) available to identify the location of the target.

The positioning data may be data directly collected by the financial information acquisition device 110 or data collected by the communication infrastructure associated with the financial information acquisition device 110. The communication infrastructure associated with the financial information acquisition device 110 may be a communication infrastructure located closest to the financial information acquisition device 110 or a communication infrastructure having the highest communication signal strength with the financial information acquisition device 110. For example, when mounted with the GPS receiver, the financial information acquisition device 110 may directly communicate with a GPS satellite to acquire the GPS information and transmit the same to the server 120 for providing the movables management service. For another example, when not mounted with the GPS receiver or unable to receive a GPS signal, the financial information acquisition device 110 may receive the GPS information acquired by the communication infrastructure communicating with the GPS satellite, and transmit the acquired GPS information to the server 120 for providing the movables management service. The server 120 for providing the movables management service may also receive the GPS information of the communication infrastructure by directly communicating with the communication infrastructure without communicating with the financial information acquisition device 110.

Meanwhile, the server 120 for providing the movables management service may verify the location information of the movables based on the positioning data. That is, the server 120 can determine whether the location information is reliable by verifying the validity of the location information. For example, when receiving the positioning data from the financial information acquisition device 110, the server 120 may derive the location information from the positioning data, and determine whether the location information indicates a location where the movables can be actually located or a location where the vehicle can be moved. In order to perform the verification, the server 120 for providing the movables management service may store map information in advance and determine whether the location information derived by mapping the location information to the map information is valid.

Meanwhile, the server 120 for providing the movables management service may determine the location information of the movables based on the positioning data. For example, when receiving the GPS information of the financial information acquisition device 110, the server 120 may determine a location indicated by the GPS information of the financial information acquisition device 110 as the location of the movables. For another example, when receiving the GPS information of the communication infrastructure from the financial information acquisition device 110, the server 120 may determine that the movables is located in the vicinity of the communication infrastructure. For still another example, when receiving the GPS information of the financial information acquisition device 110 and the GPS information of the communication infrastructure, the server 120 may determine the location of the movables by selecting a more reliable one of the GPS information of the financial information acquisition device 110 and the GPS information of the communication infrastructure. Here, reliability of the GPS information may be determined based on a priority separately set by the server 120 for providing the movables management service. For example, when receiving both of the GPS information of the financial information acquisition device 110 and the GPS information of the communication infrastructure, the server 120 may determine the location indicated by the GPS information of the financial information acquisition device 110 as the location of the movables based on a higher priority of the GPS information of the financial information acquisition device 110.

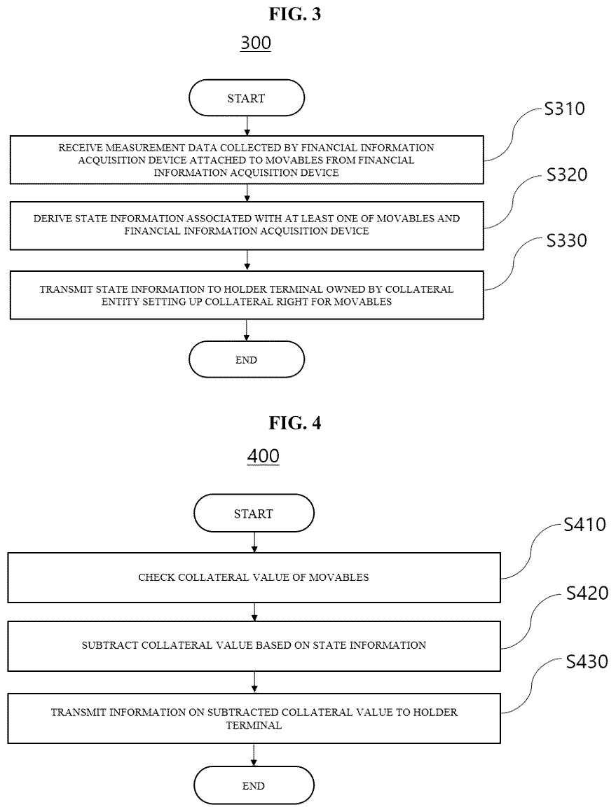

FIG. 3 is a flowchart showing a method for providing a movables management service according to another embodiment of the disclosure.

Referring to FIG. 3, the method for providing the movables management service may include steps S310 to S330. The method for providing the movables management service according to this embodiment is described as operations by the server 120 for providing the movables management service described with reference to FIG. 1.

In the step S310, the server 120 for providing the movables management service may receive the measurement data collected by the financial information acquisition device attached to the movables from the financial information acquisition device. The server 120 for providing the movables management service may receive, from the financial information acquisition device, at least one of the positioning data measured by the financial information acquisition device and the positioning data measured by the communication infrastructure associated with the financial information acquisition device. The server 120 for providing the movables management service may receive, from the financial information acquisition device, at least one of the positioning data as well as the information associated with the state measured by the financial information acquisition device and the information associated with the activation state of the movables.

In the step S320, the server 120 for providing the movables management service may derive the state information of the movables from the received measurement data. The state information may include at least one of the location information and preset event detection information of the movables. The server 120 for providing the movables management service may derive the location information from the positioning data and derive the event detection information from the information associated with the state.

In the step S330, the server 120 for providing the movables management service may transmit the state information to the holder terminal owned by the collateral entity (or the holder) setting up the collateral right for the movables. The state information may be information in the form of an image, sound, and a text, which can be output by the screen or speaker of the holder terminal. The server 120 for providing the movables management service may transmit the state information every period or in real time for the holder to monitor the movables.

Meanwhile, although not shown in the drawing, in the step S330, the server 120 for providing the movables management service may transmit the notification signal corresponding to the state information to the manager terminal preset for the movables. The notification signal may include information on a date on which the state information is derived, a date on which the state information is transmitted, and the sender and receiver of the state information. The manager can monitor whether the service providing the state information to the holder is normally performed based on the notification signal.

FIG. 4 is a detailed flowchart showing specific operations of operations performed after the step S330 of FIG. 3.

Referring to FIG. 4, steps S410 to S430 are described as operations by the server 120 for providing the movables management service. The server 120 for providing the movables management service may perform steps S410 to S430 after performing the step S330 described above with reference to FIG. 3.

In the step S410, the server 120 for providing the movables management service may check the collateral value of the movables. The server 120 for providing the movables management service may derive the state information from the measurement data continuously received from the financial information acquisition device before performing the step S410 and store the derived state information. Accordingly, the server 120 for providing the movables management service may generate analysis information associated with movables based on at least one state information derived from at least one measurement data previously received from the financial information acquisition device and the state information derived at a current time point. Here, the analysis information associated with the movables may be information on the collateral value of the movables. That is, the server 120 for providing the movables management service can adjust a change in the value of the movables held as the collateral in real time.

To this end, the server 120 for providing the movables management service may subtract the collateral value of the movables based on current state information and at least one state information at the previous time point in the step S420. The server 120 for providing the movables management service may store the collateral value (or money amount) set for the movables at a time point when the movables is held as the collateral. In addition, the server 120 may subtract the preset collateral value based on information (e.g., number of activations or moving distance of the movables) included in the state information of movables. For example, the server 120 may subtract n Korean won from an initial collateral value whenever the movables is moved by 10 km.

In the step S430, the server 120 for providing the movables management service may transmit information (i.e., analysis information) on the subtracted collateral value to the holder terminal. The server 120 for providing the movables management service may transmit the information on the changed value of the movables, thereby providing a service for the holder who sets up the collateral right to monitor the change in the value of the movables.

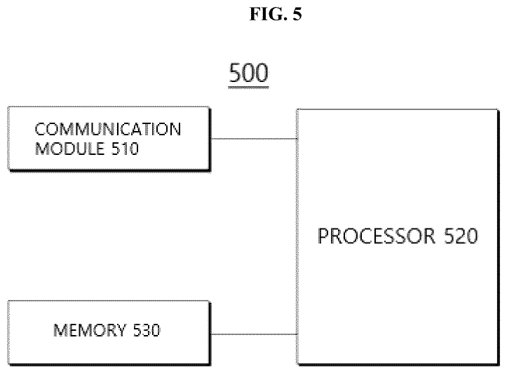

FIG. 5 is a block diagram of a server for providing a movables management service according to still another embodiment of the disclosure.

Referring to FIG. 5, a server 500 for providing a movables management service may include a communication module 510, a processor 520, and a memory 530. The server 500 for providing the movables management service may be implemented as the server 120 for providing the movables management service described above with reference to FIG. 1.

The communication module 510 may receive the measurement data collected by the financial information acquisition device from the financial information acquisition device. The communication module 510 may be implemented as a module or a modem, which may perform mobile communication such as 3G, 4G, or 5G with the financial information acquisition device or the communication infrastructure.

The processor 520 may derive the state information from the received measurement data. The processor 520 may be implemented as the central processing unit (CPU) or application processor (AP) of the server 500 for providing the movables management service.

The memory 530 may store the state information derived by the processor 520. The memory 530 may be implemented as a storage such as the hard disk drive (HDD) or solid state drive (SSD) of the server 500 for providing the movables management service.

Meanwhile, the server 500 for providing the movables management service described above may be implemented as a program (or an application) including an executable algorithm that can be executed on a computer. The program may be stored and provided in a transitory computer readable medium or a non-transitory computer readable medium.

The disclosure describes the method, the server, and the system for providing the movables management service according to the embodiments of the disclosure with reference to the embodiments shown in the drawings for better understanding, which are only provided as examples, and those skilled in the art may understand that various modifications and equivalent other embodiments are possible therefrom. Therefore, the scope of the disclosure should be determined by the appended claims.

What is claimed is:

1. A method for providing a movables management service that is performed by a server for providing a movables management, the method comprising:
receiving measurement data collected by a financial information acquisition device attached to a movables from the financial information acquisition device;
deriving state information associated with at least one of the movables and the financial information acquisition device from the measurement data; and
transmitting the state information to a holder terminal owned by a collateral entity setting up a collateral right for the movables,
wherein the state information includes at least one of the location information and preset event detection information of the movables.

2. The method of claim 1, wherein the location information is derived from positioning data acquired from at least one of the financial information acquisition device and a communication infrastructure associated with the financial information acquisition device.

3. The method of claim 1, wherein the event detection information is derived by detecting at least one of a first event associated with a state of the financial information acquisition device and a second event associated with the location information and activation state of the movables.

4. The method of claim 1, further comprising:
storing the state information; and
generating analysis information associated with the movables based on the state information and at least one state information derived from at least one measurement data previously received from the financial information acquisition device.

5. The method of claim 4, wherein the generating of the analysis information includes:
checking a predetermined collateral value of the movables;
subtracting the predetermined collateral value based on the state information and the at least one state information; and
transmitting information on the subtracted collateral value to the holder terminal.

6. The method of claim 1, wherein the transmitting of the state information further includes
transmitting a notification signal corresponding to the state information to a manager terminal preset for the movables.

7. A server for providing a movables management service, the server comprising:
a communication module receiving measurement data collected by a financial information acquisition device attached to a movables from the financial information acquisition device and transmitting state information to a holder terminal owned by a collateral entity setting up a collateral right for the movables; and
a processor deriving the state information associated with at least one of the movables and the financial information acquisition device from the measurement data,
wherein the state information includes at least one of the location information and preset event detection information of the movables.

8. The server of claim 7, wherein the location information is derived from positioning data acquired from at least one of the financial information acquisition device and a communication infrastructure associated with the financial information acquisition device.

9. The server of claim 7, wherein the event detection information is derived by detecting at least one of a first event associated with a state of the financial information acquisition device and a second event associated with the location information and activation state of the movables.

10. The server of claim 7, further comprising a memory storing the state information,
wherein the processor generates analysis information associated with the movables based on the state information and at least one state information derived from at least one measurement data previously received from the financial information acquisition device.

11. The server of claim 10, wherein the processor checks a predetermined collateral value of the movables, subtracts the predetermined collateral value based on the state information and the at least one state information, and transmits information on the subtracted collateral value to the holder terminal.

12. The server of claim 7, wherein the communication module transmits a notification signal corresponding to the state information to a manager terminal preset for the movables.

13. A system for providing a movables management service, the system comprising:
a financial information acquisition device attached to a movables to collect measurement data of the movables;
a server for providing a movables management service receiving the measurement data from the financial information acquisition device and deriving state information associated with at least one of the movables and the financial information acquisition device from the measurement data; and
a holder terminal owned by a collateral entity setting up a collateral right for the movables and receiving the state information.

14. The system of claim 13, wherein location information is derived from positioning data acquired from at least one of the financial information acquisition device and a communication infrastructure associated with the financial information acquisition device.

15. The system of claim 13, wherein event detection information is derived by detecting at least one of a first event associated with a state of the financial information acquisition device and a second event associated with the location information and activation state of the movables.

16. The system of claim 13, wherein the server for providing the movables management service stores the state information, and
generates analysis information associated with the movables based on the state information and at least one state information derived from at least one measurement data previously received from the financial information acquisition device.

17. The system of claim 16, wherein the server for providing the movables management service checks a predetermined collateral value of the movables, subtracts the predetermined collateral value based on the state information and the at least one state information, and transmits information on the subtracted collateral value to the holder terminal.

18. The system of claim 13, wherein the server for providing the movables management service transmits a notification signal corresponding to the state information to a manager terminal preset for the movables.
